(19) United States
(12) Patent Application Publication
(10) Pub. No.: US 2023/0053486 A1
(43) Pub. Date: Feb. 23, 2023

(54) MAINTENANCE MANAGEMENT SYSTEM, MESSAGE CONTROL APPARATUS, MESSAGE CONTROL METHOD, AND PROGRAM

(71) Applicant: Nippon Telegraph and Telephone Corporation, Tokyo (JP)

(72) Inventors: Tomoki IKEGAYA, Musashino-shi, Tokyo (JP); Satoshi KONDO, Musashino-shi, Tokyo (JP); Kensuke TAKAHASHI, Musashino-shi, Tokyo (JP)

(21) Appl. No.: 17/797,187

(22) PCT Filed: Feb. 5, 2020
(86) PCT No.: PCT/JP2020/004359

§ 371 Date: Aug. 3, 2022

(51) Int. Cl. G06Q 10/00

(52) U.S. Cl. CPC G06Q 10/20

(57) ABSTRACT

There is provided a maintenance management system including a plurality of operation components that transmit and receive a message and autonomously operate and a message control device that controls the message transmitted and received among the operation components, the maintenance management system maintaining and managing a service. Each of the operation components executes a predetermined action when receiving a message addressed to the operation component and, when the execution of the action is successful, transmits, to a transmission source, a message to which a label allocated to the operation component is given. The message control device receives the message transmitted by the operation component, determines the operation component at the transmission destination from a label given to the transmission source of the message, and transmits the message to the operation component at the transmission destination.

### TECHNICAL FIELD

The present invention relates to a maintenance management system, a message control device, a message control method, and a program.

### BACKGROUND ART

According to the spread of a network environment, use of services provided via networks has been expanding. Service maintenance work for monitoring the quality of a service and presence or absence of failure occurrence and performing an analysis and restoration according to necessity has been performed. The service maintenance work is realized centering on determination based on knowledge and knowhow of an operator and takes labor and time. In particular, in recent years, according to the spread of B2B2X, services providing a plurality of services in association with one another have been increasing. The service maintenance work also requires maintenance and operation that associate a plurality of services with one another.

Non-Patent Literature 1 proposes, as a technique for automating service maintenance work, an autonomous control loop scheme for segmenting and autonomizing functions of a maintenance operation to autonomously determine an operation simply by incorporating new operation components in a system. In the autonomous control loop scheme, a message is transmitted and received among operation components divided for each of functions. Each of the operation components autonomously operates based on the received message.

### CITATION LIST

### Non-Patent Literature

Non-Patent Literature 1: Naoyuki Tanji, other two, “Proposal of an Autonomous Control Loop Scheme by Segmentation and Autonomy of Maintenance Functions”, IEICE Technical Report, IEICE, July 2018, Vol. 118, No. 118, pp. 13 to 18

### SUMMARY OF THE INVENTION

### Technical Problem

In the conventional automatic control loop scheme, a message is broadcasted to all operation components. The operation components determine, based on the message and a firing rule retained by the operation components, whether to execute actions or not to do anything. In the firing rule, conditions specific to the operation components and actions to be executed are set. When conditions of the firing rule are satisfied for the received messages, the operation components execute predetermined actions and transmit the message after the action execution. Contents based on execution results specific to the operation components are given to the message. The message is broadcasted to all the operation components. Each of the operation components receives the message and autonomously operates based on the firing rule.

When a new operation component is added or an operation component is repaired, it is necessary to repair related other operation components if the conditions specific to the operation components set in the firing rule and action contents to be executed are changed. If the addition of the new operation components and the repair of the operation components can be performed in a short period, it is possible to follow adaptation to a new service and a specification change of a service in a timely manner.

The present invention has been devised in view of the above, and an object of the present invention is to reduce the influence of addition and repair of operation components in the automatic control loop scheme.

### Means for Solving the Problem

A maintenance management system according to an aspect of the present invention is a maintenance management system including a plurality of operation component devices that transmit and receive a message and autonomously operate and a message control device that controls the message transmitted and received among the operation component devices, the maintenance management system maintaining and managing a service, wherein each of the operation component devices executes a predetermined action when receiving a message addressed to the operation component device and, when the execution of the action is successful, transmits, to a transmission source, a message to which a label allocated to the operation component device is given, and the message control device receives the message transmitted by the operation component device, determines the operation component device at the transmission destination from a label given to the transmission source of the message, and transmits the message to the operation component device at the transmission destination.

### Effects of the Invention

According to the present invention, it is possible to reduce the influence of addition and repair of operation components in the automatic control loop scheme.

### BRIEF DESCRIPTION OF DRAWINGS

FIG. 1 is a diagram showing an example of an overall configuration of a maintenance management system in an embodiment.

FIG. 2 is a diagram showing an example of a table retained by a label management unit.

FIG. 3 is a diagram showing a configuration example of an operation component included in the maintenance management system.

FIG. 4 is a flowchart showing a flow of processing at the time when the operation component receives a message.

FIG. 5 is a flowchart showing a flow of processing of a message control device.

FIG. 6 is a diagram for explaining a flow of messages among function types.

FIG. 7 is a diagram for explaining a flow of messages among operation components.

FIG. 8 is a diagram showing an example of a hardware configuration of the operation component and the message control device.

### DESCRIPTION OF EMBODIMENTS

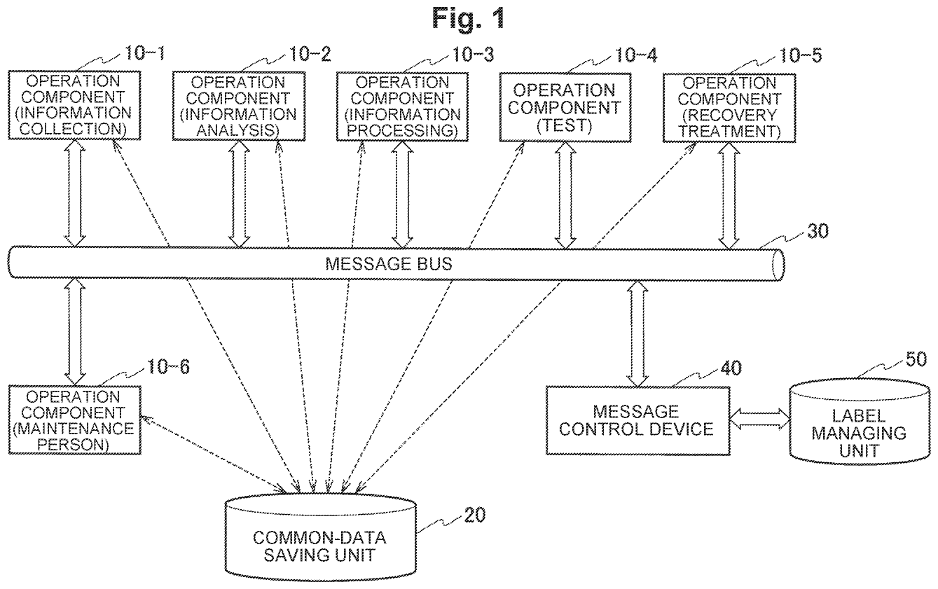

A maintenance management system in an embodiment is explained with reference to FIG. 1. The maintenance management system in this embodiment adopts an autonomous control loop scheme in which operation components 10-1 to 10-6 not having a connection relation one another actively check situations of a service and an alarm and autonomously determine and execute necessary processing.

The operation components 10-1 to 10-6 are devices or processes that autonomously operate. Each of the operation components 10-1 to 10-6 is segmented in units of maintenance functions and has a specific maintenance function. For example, the operation components 10-1 to 10-6 are classified into six function types of information collection, information processing, information analysis, test, recovery treatment, and maintenance person. Overviews of the operation components of the types are described below.

[Information collection] Performing information collection from a maintenance target service environment.

[Information processing] Performing irreversible time-series/character string processing such as noise removal, correlation calculation, characteristics/keywords extraction, and statistical processing and visualization.

[Information analysis] Performing information analyses such as classification, prediction, and state estimation for abnormality determination and clustering and generation of an analysis result.

[Test] Performing generation and transmission of test traffic.

[Recovery treatment] Performing an operation for recovering a service.

[Maintenance person] Providing a user interface for a maintenance person to control operation components.

Note that the maintenance management system may not include all of the operation components of the six function types described above or may include operation components other than the function types described above. The maintenance management system may include a plurality of operation components of the same function type. For example, when maintaining a service provided by associating a plurality of services, the maintenance management system includes the operation components for each of the function types described above for each of the plurality of services. In the following explanation, when it is unnecessary to distinguish the function types of the operation components 10-1 to 10-6, the operation components 10-1 to 10-6 are sometimes simply referred to as operation components 10.

The operation components 10 execute actions when receiving a message addressed to the operation components 10. The actions indicate operation contents of the operation components 10 and are equivalent to functions at the time when the operation components 10 are segmented in units of maintenance functions. A common-data saving unit 20 retains information utilized in common in each of the operation components 10. When executing the actions, the operation components 10 save information in the common-data saving unit 20 and acquire information from the common-data saving unit 20.

When succeeding in the execution of the actions, the operation components 10 transmits messages to a message bus 30. When failing in the execution of the actions, the operation components 10 complete operations without transmitting messages. When transmitting the messages, the operation components 10 give labels allocated to the operation components 10 themselves to the messages. The labels are allocated to each of the operation components 10 for each of the function types. For example, an “information collection” label is given to the operation component 10-1. For example, an “information collection” label, an “information processing” label, an “information analysis” label, a “test” label, a “recovery treatment” label, and a “maintenance person” label are respectively given to the operation components 10-1 to 10-6. One label may be given to a plurality of operation components 10.

A message control device 40 receives a message from the message bus 30, determines a transmission destination of the message based on a label given to the message, and multicasts the message to one or more operation components 10. That is, in this embodiment, the message is not broadcasted to all the operation components 10.

A label management unit 50 manages a label giving rule for allocating labels of each of the function types to each of the operation components 10 and a message transmission rule for determining a transmission destination from a label of a transmission source.

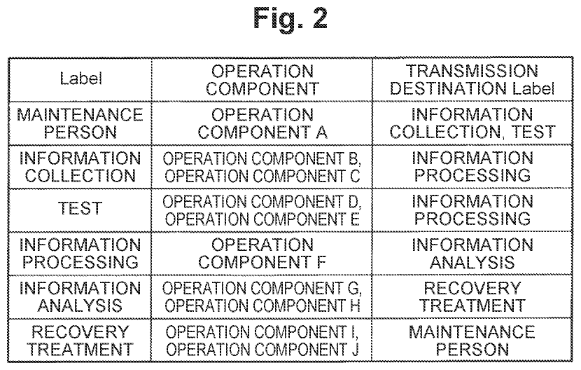

An example of a table managed by the label management unit 50 is shown in FIG. 2. In the table shown in FIG. 2, allocation of the labels for each of the function types to operation components A to J is managed. Specifically, the “maintenance person” label is allocated to the operation component A, the “information collection” label is allocated to the operation component B and the operation component C, the “test” label is allocated to the operation component D and the operation component E, the “information processing” label is allocated to the operation component F, the “information analysis” label is allocated to the operation component G and the operation component H, and the “recovery treatment” label is allocated to the operation component I and the operation component J. The operation components A to J are, for example, identifiers for identifying the operation components 10.

In the table shown in FIG. 2, a relation of labels of transmission destinations with labels of transmission sources given to messages are managed. Specifically, it is determined that a message having the “maintenance person” label as a transmission source has the “information collection” label and the “test” label as transmission destinations, a message having the “information collection” label as a transmission destination has the “information processing” label as a transmission destination, a message having the “test” label as a transmission destination has the “information processing” label as a transmission destination, a message having the “information processing” label as a transmission destination has the “information analysis” label as a transmission destination, a message having the “information analysis” label as a transmission destination has the “recovery treatment” label as a transmission destination, and a message having the “recovery treatment” label as a transmission destination has the “maintenance person” label as a transmission destination.

In an example of the table shown in FIG. 2, the “maintenance person” label is given to a transmission source of a message transmitted by the operation component A. In the message, to the transmission source of which the “maintenance person” label is given, the “information collection” label and the “test” label are given to a transmission destination. The “information collection” label is allocated to the operation component B and the operation component C. The “test” label is allocated to the operation component D and the operation component E. That is, the message transmitted by the operation component A is transmitted to the operation component B and the operation component C and to the operation component D and the operation component E.

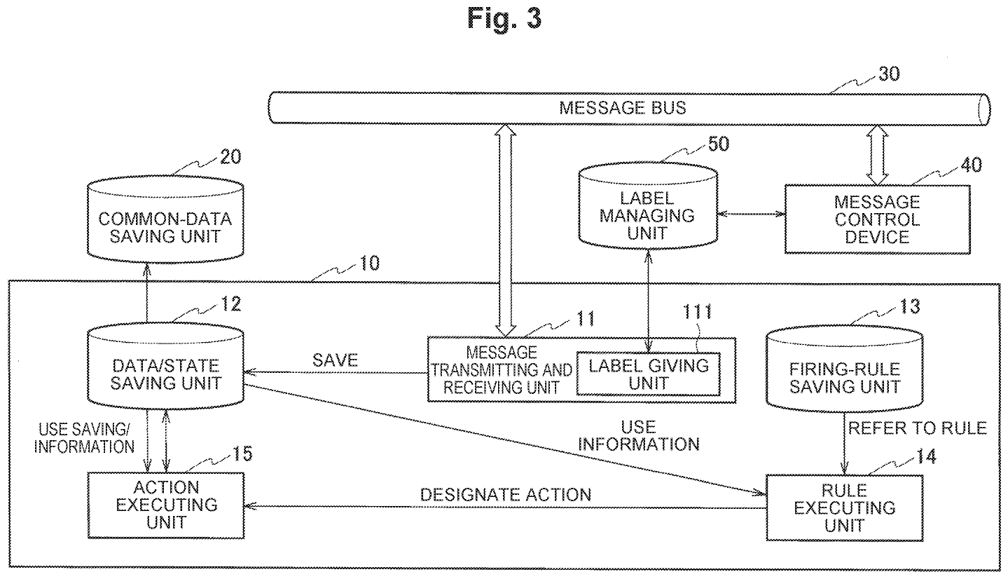

The configuration of the operation components included in the maintenance management system is explained with reference to FIG. 3. The operation components 10-1 to 10-6 shown in FIG. 1 have the same configuration as the operation component 10 shown in FIG. 3.

The operation component 10 includes a message transmission and reception unit 11, a data/state saving unit 12, a firing-rule saving unit 13, a rule execution unit 14, and an action execution unit 15.

The message transmission and reception unit 11 receives, via the message bus 30, a message addressed to the message transmission and reception unit 11, to a transmission destination of which a label allocated to the operation component 10 itself is given. When an action by the action execution unit 15 is successful, the message transmission and reception unit 11 creates a message based on an execution result of the action and transmits the message to the message bus 30. When the action by the action execution unit 15 is unsuccessful, the message transmission and reception unit 11 does not transmit a message.

When the message transmission and reception unit 11 transmits the message, a label giving unit 111 acquires, from the label management unit 50, a label allocated to the operation component 10 itself and gives the label allocated to the operation component 10 itself to a transmission source of the message.

The data/state saving unit 12 retains data and states such as the received message and the execution result of the action execution unit 15. The data/state saving unit 12 may retain data acquired from the common-data saving unit 20 or may temporarily retain data to be stored in the common-data saving unit 20 and store the data in the common-data saving unit 20. The action execution unit 15 may use the data and the states retained by the data/state saving unit 12 when executing an action.

The firing-rule saving unit 13 retains a firing rule for individually defining, for each of the operation components 10, information designating an action to be executed. The firing rule may designate an action to be executed according to a label of a transmission source of a received message. For example, the operation component 10 to which the “information processing” label is given retains a firing rule for designating an action executed when a message having the “information collection” label as a transmission source is received and a firing rule for designating an action executed when a message having the “test” label as a transmission source is received.

The rule execution unit 14 fires for all received messages and instructs the action execution unit 15 to execute an action. Specifically, when the message transmission and reception unit 11 receives a message addressed to the message transmission and reception unit 11, the rule execution unit 14 acquires a firing rule saved in the firing-rule saving unit 13 and notifies an action to be executed to the action execution unit 15.

The action execution unit 15 receives the instruction from the rule execution unit 14, refers to the data retained by the data/state saving unit 12 and the data retained by the common-data saving unit 20, and executes the action notified from the rule execution unit 14. When the action by the action execution unit 15 is successful, a message, to a transmission source of which a label of the message transmission and reception unit 11 is given, is transmitted by the message transmission and reception unit 11. The action by the action execution unit 15 is sometimes unsuccessful because of a factor such as data shortage. When the action execution unit 15 fails in the execution of the action, a message is not transmitted.

Subsequently, the operations of the operation component 10 and the message control device 40 are explained.

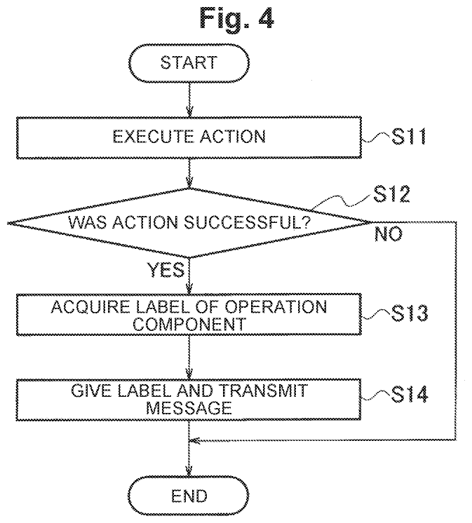

First, an operation at the time when the operation component 10 receives a message is explained with reference to a flowchart of FIG. 4. When receiving a message addressed to the operation component 10, the operation component 10 starts processing shown in FIG. 4.

In step S11, the operation component 10 executes a designated action.

In step S12, the operation component 10 determines whether the execution of the action was successful. If the execution of the action was unsuccessful, the operation component 10 completes the operation.

When the execution of the action was successful, in step S13, the operation component 10 acquires, from the label management unit 50, a label allocated to the operation component 10.

In step S14, the operation component 10 transmits a message, to a transmission source of which the acquired label is given.

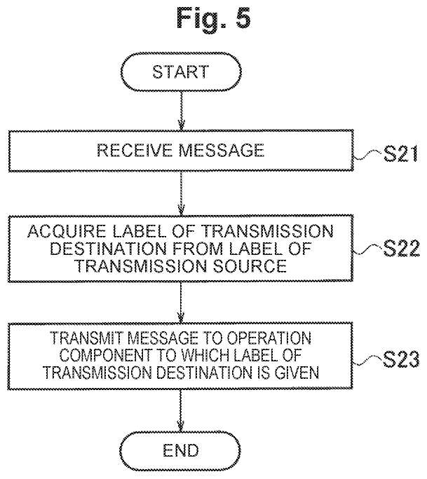

Subsequently, the operation of the message control device 40 is explained with reference to a flowchart of FIG. 5.

In step S21, the message control device 40 receives a message transmitted by the operation component 10.

In step S22, the message control device 40 acquires, from the label management unit 50, a label of a transmission destination corresponding to a label of a transmission source given to the message.

In step S23, the message control device 40 transmits the message to the operation component 10 to which the label of the transmission destination is allocated.

Thereafter, the operation component 10 receives the message and starts the processing shown in FIG. 4. The processing shown in FIGS. 4 and 5 is repeated and the operation components 10 divided for each of functions autonomously operate.

Subsequently, a flow of messages in the maintenance management system in this embodiment is explained.

As shown in the table shown in FIG. 2, it is assumed that the label management unit 50 allocates the labels for each of the function types to each of the operation components A to J and retains the relation of the labels of the transmission destinations with the labels of the transmission sources.

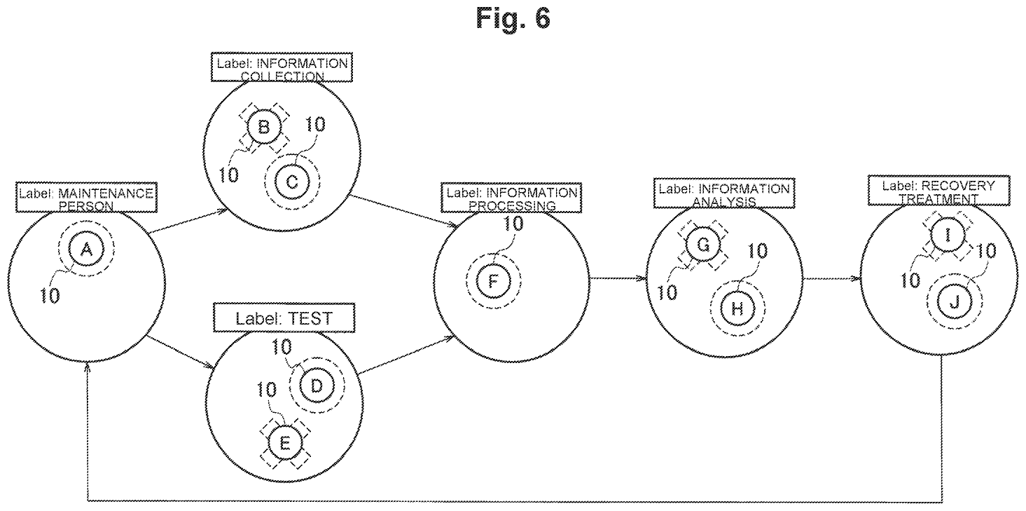

When the label management unit 50 retains the table shown in FIG. 2, a flow of messages among the operation components 10 divided for each of the function types is as shown in FIG. 6. In FIG. 6, a transmission rule of a message managed in the table shown in FIG. 2 is indicated using arrows.

For example, the “information collection” label and the “test” label are given to a transmission destination of a message, to a transmission source of which the “maintenance person” label is given. The message is transmitted to the operation components B and C to which the “information collection” label is allocated and the operation components D and E to which the “test” label is allocated.

The “information processing” label is given to a transmission destination of a message, to a transmission source of which the “information collection” label is given, and a message, to a transmission source of which the “test” label is given. The messages are transmitted to the operation component F to which the “information processing” label is allocated.

The “information analysis” label is given to a transmission destination of a message, to a transmission source of which the “information processing” label is given. The message is transmitted to the operation components G and H to which the “information analysis” label is allocated.

The “recovery treatment” label is given to a transmission destination of a message, to at transmission source of which the “information analysis” label is given. The message is transmitted to the operation components I and J to which the “recovery treatment” label is allocated.

The “maintenance person” label is given to a transmission destination of a message, to a transmission source of which the “recovery treatment” label is given. The message is transmitted to the operation component A to which the “maintenance person” label is allocated.

Note that FIG. 6 shows that the operation components A, C, D, F, H, and J have succeeded in execution of actions and the operation components B, E, G, and I have failed in execution of actions. Each of the operation components A, C, D, F, H, and J which have succeeded in execution of actions transmits a message.

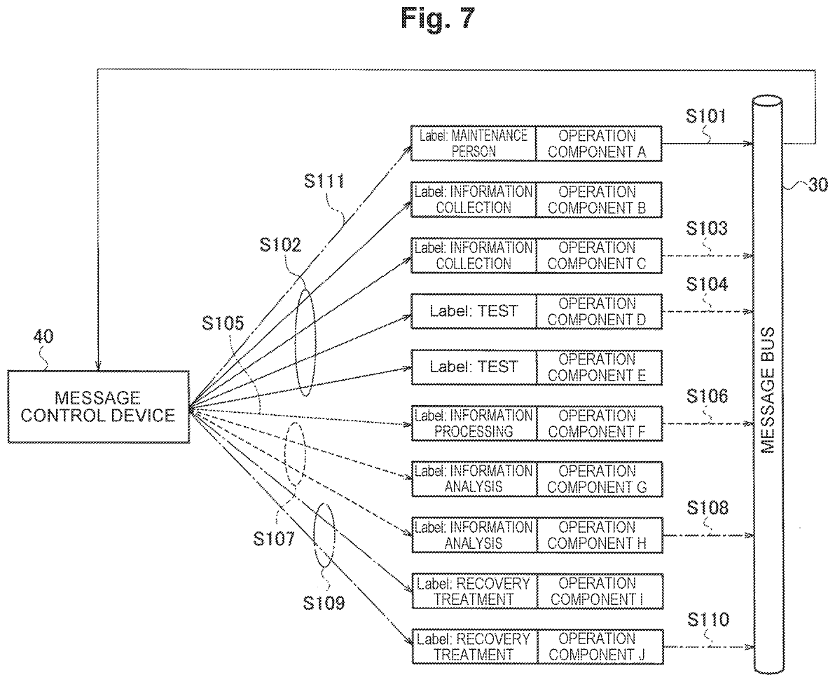

A flow of messages transmitted and received by each of the operation components A to J is explained with reference to FIG. 7.

First, in step S101, the operation component A transmits a message, to a transmission source of which the “maintenance person” label is given. For example, at a failure occurrence time, when a maintenance administrator notifies the failure occurrence to the maintenance management system using a user interface provided by the operation component A, the operation component A executes an action and transmits the message. The message includes information such as an information collection target, an information collection content, a test target, and a test content corresponding to the occurred failure.

The message control device 40 receives, from the message bus 30, the message transmitted by the operation component A and acquires the “information collection” label and the “test” label as transmission destinations corresponding to the “maintenance” label of the transmission source.

In step S102, the message control device 40 gives the “information collection” label and the “test” label to the transmission destination of the message and transmits the message to the operation components B and C and the operation components D and E.

The operation components B and C and the operation components D and E receiving the message execute actions. It is assumed that the operation component C and the operation component D have succeeded in the execution of the actions and the operation component B and the operation component E have failed in the execution of the actions. The operation component B and the operation component E complete the operations without transmitting messages. For example, the operation component B has failed in the execution of the action because the operation component B does not perform information collection of a target, information of which the maintenance administrator desires to collect. The operation component E has failed in the execution of the action because the operation component E does not execute a test desired by the maintenance administrator. The operation component C has collected information from an information collection target. The operation component D has tested a test target.

When succeeding in the execution of the action, in step S103, the operation component C transmits a message, to a transmission source of which the “information collection” label is given. For example, the operation component C transmits a message indicating that the information collection from the information collection target is completed.

When succeeding in the execution of the action, in step S104, the operation component D transmits a message, to a transmission source of which the “test” label is given. For example, the operation component D transmits a message indicating that the test for the test target is completed.

The message control device 40 receives, from the message bus 30, the message transmitted by the operation component C and acquires the “information processing” label as a transmission destination corresponding to the “information collection” label of the transmission source. The message control device 40 receives, from the message bus 30, the message transmitted by the operation component D and acquires the “information processing” label as a transmission destination corresponding to the “test” label of the transmission source.

In step S105, the message control device 40 gives the “information processing” label to a transmission destination of each of the message transmitted by the operation component C and the message transmitted by the operation component D and transmits these messages to the operation component F.

The operation component F receiving the message executes an action.

When succeeding in the execution of the action, in step S106, the operation component F transmits a message, to a transmission source of which the “information processing” label is given. For example, the operation component F processes the collected information, processes the test result, and transmits a message indicating that the processing of the information is completed. The operation component F may transmit the message at each time after the collected information is processed and after the test result is processed or may transmit the message after both of the processing of the collected information and the processing of the test result are completed.

The message control device 40 receives, from the message bus 30, the message transmitted by the operation component F and acquires the “information analysis” label as a transmission destination corresponding to the “information processing” label of the transmission source.

In step S107, the message control device 40 gives the “information analysis” label to the transmission destination of the message transmitted in step S106 and transmits the message to the operation components G and H.

The operation components G and H receiving the message execute actions. It is assumed that the operation component H has succeeded in the execution of the action and the operation component G has failed in the execution of the action.

When succeeding in the execution of the action, in step S108, the operation component H transmits a message, to a transmission source of which the “information analysis” label is given. For example, the operation component H transmits a message including an information analysis result.

The message control device 40 receives, from the message bus 30, the message transmitted by the operation component H and acquires the “recovery treatment” label as a transmission destination corresponding to the “information analysis” label of the transmission source.

In step S109, the message control device 40 gives the “recovery treatment” label to the transmission destination of the message transmitted in step S108 and transmits the message to the operation components I and J.

The operation components I and J receiving the message execute actions. It is assumed that the operation component J has succeeded in the execution of the action and the operation component I has failed in the execution of the action.

When succeeding in the execution of the action, in step S110, the operation component J transmits a message, to a transmission source of which the “recovery treatment” label is given. For example, the operation component J selects recovery treatment based on the analysis result and transmits a message for showing the selected recovery treatment and obtaining approval of the maintenance administrator and transmits a message including a result of execution of the recovery treatment.

The message control device 40 receives, from the message bus 30, the message transmitted by the operation component J and acquires the “maintenance person” label as a transmission destination corresponding to the “recovery treatment” label of the transmission source.

In step S111, the message control device 40 gives the “maintenance person” label to the transmission destination of the message transmitted in step S110 and transmits the message to the operation component A.

In this way, the message control device 40 controls a transmission destination of a message based on a label of a transmission source of the message. The operation components A to J receiving the message execute actions and transmit messages. Consequently, a maintenance operation by the maintenance management system is executed.

As explained above, in the maintenance management system in this embodiment, the operation component 10 transmits a message, to a transmission source of which a label allocated to the operation component 10 is given. The message control device 40 acquires a label of a transmission destination corresponding to the label given to the transmission source of the message and transmits the message to the operation component 10 to which the label of the transmission destination is allocated. The operation component 10 receiving the message executes an action and, when the action is successful, transmits the message. Since the operation component 10 operates based not on information specific to an operation component but on a label given to a message, even when a new operation component 10 is added or the operation component 10 is repaired, it is possible to reduce the influence on the existing operation components 10.

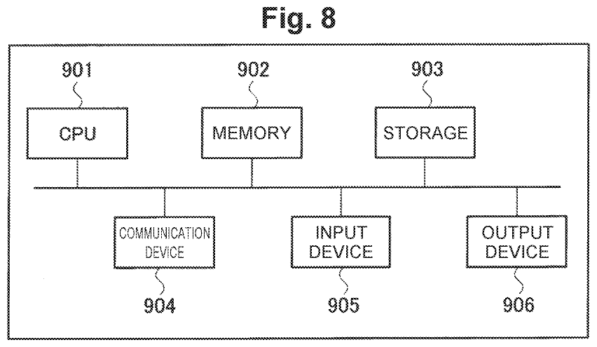

As the operation components 10 and the message control device 40 explained above, for example, a general-purpose computer system including a central processing unit (CPU) 901, a memory 902, a storage 903, a communication device 904, an input device 905, and an output device 906 shown in FIG. 8 can be used. In this computer system, the CPU 901 executes a predetermined program loaded on the memory 902, whereby the operation components 10 and the message control device 40 are realized. The program can be recorded in a computer-readable recording medium such as a magnetic disk, an optical disk, or a semiconductor memory or can be distributed via a network.

### REFERENCE SIGNS LIST

10-1 to 10-6, 10 Operation component

11 Message transmission and reception unit

111 Label giving unit

12 Data/state saving unit

13 Firing-rule saving unit

14 Rule execution unit

15 Action execution unit

20 Common-data saving unit

30 Message bus

40 Message control device

50 Label management unit

1. A maintenance management system comprising: a plurality of operation component devices that transmit and receive one or more messages and autonomously operate; and a message control device that controls the one or more messages transmitted and received among the operation component devices, the maintenance management system maintaining and managing a service, wherein
each of the operation component devices executes a predetermined action when receiving a message addressed to the operation component device and, when the predetermined action is successfully executed, transmits, to a transmission source, a message to which a label allocated to the operation component device is given, and
the message control device:
receives the message transmitted by the operation component device;
determines the operation component device at the transmission destination from a label given to the transmission source of the message; and
transmits the message to the operation component device at the transmission destination.

2. The maintenance management system according to claim 1, further comprising a label management device that allocates labels for each of function types to the operation component devices and manages a relation of labels of transmission destinations with labels of transmission sources, wherein the message control device:
acquires, from the label management device, a label of a transmission destination corresponding to the label given to the transmission source of the message; and
transmits the message to all the operation component devices to which the label of the transmission destination is allocated.

3. A message control device that controls a message transmitted and received among a plurality of operation component devices that autonomously operate, the message control device being configured to perform operations comprising:
receiving the message;
determining an operation component device at a transmission destination from a label given to a transmission source of the message; and
transmitting the message to the operation component device at the transmission destination.

4. The message control device according to claim 3, wherein the message control device:
acquires, from a label management device that manages a relation of labels of transmission destinations with labels of transmission sources, a label of a transmission destination corresponding to the label given to the transmission source of the message; and
transmits the message to all the operation component devices to which the label of the transmission destination is allocated.

5. A message control method executed by a message control device that controls a message transmitted and received among a plurality of operation component devices that autonomously operate, the message control method comprising:
receiving the message;
determining an operation component device at a transmission destination from a label given to a transmission source of the message; and
transmitting the message to the operation component device at the transmission destination.

6. (canceled)
